(19) United States
(12) Patent Application Publication
(10) Pub. No.: US 2014/0143069 A1
(43) Pub. Date: May 22, 2014

(54) Direct Marketing Line Overlay of Product Lines and Divisions

(71) Applicant: Melyn Campbell, Salt Lake City, UT (US)

(72) Inventor: Melyn Campbell, Salt Lake City, UT (US)

(21) Appl. No.: 13/866,016

(22) Filed: Apr. 18, 2013

Related U.S. Application Data
(60) Provisional application No. 61/635,142, filed on Apr. 18, 2012.

(51) Int. Cl. G06Q 30/02

(52) U.S. Cl. CPC G06Q 30/0277
USPC 705/14.73

(57) ABSTRACT

A method for extending direct marketing services entails utilizes an existing direct marketing network to provide direct marketing services to a company that does not have its own direct marketing network. A new compensation system is overlaid on an existing direct marketing network. The new compensation system corresponds to distribution of one or more products of the company that does not have its own direct marketing network. The new compensation system is overlaid on the existing direct marketing network without disturbing an existing compensation system for existing products already distributed through the existing direct marketing network.

### CROSS-REFERENCE TO RELATED APPLICATIONS

This application claims the benefit of U.S. Provisional Application No. 61/635,142, filed Apr. 18, 2012.

### BACKGROUND OF THE INVENTION

1. Field of the Invention

The present invention relates to direct marketing, and more particularly to systems and methods for expanding markets and product lines for direct marketing.

2. Background and Related Art

Globally in 2009, Direct Selling total sales totaled over $117 billion with 74 million sellers worldwide. The United States was the lead country in these statistics with $28.3 billion in sales and 16.1 million salespeople. According to industry statistics from dsa.org, the U.S. Direct Selling Association (DSA) has 203 member companies and 41 newcomer, pending-member companies. Clearly the MLM sales model for companies has had continued success.

As an MLM company grows and a network of distributors has been built, the goal becomes to keep as many distributors as possible, while still growing the company and the network. Keeping distributors excited about the company opportunity/story when it begins to feel like an old story becomes a challenge. Newer distributors are soon at risk of leaving for a new “shiny” story with a different company.

Independent Distributors are just that, independent: they can sell/distribute any product for any company and build any network. Sometimes distributors just leave a company to go with another opportunity. But sometimes, distributors will try to participate in more than one company with the challenge of getting their downline to follow them so they can leverage their income in both companies. Either way, the distributor bears a risk that the structure of his or her downline organization will scatter. With that being said, the one restriction an MLM company can place in its policies and procedures is that a distributor can only recruit to other companies those whom they have personally sponsored in said MLM company. Personally recruiting any other distributor relationship would constitute a violation of Policies and Procedures and create a cause for termination.

One of the greatest perceived dangers to any company and its leaders is when a new company comes to town flaunting a “grass is greener” opportunity under the noses of their distributor base that has little to lose by making the switch to the shiny, new ground-floor opportunity. The excitement of going through pre-launch, being first in the next “big one,” is definitely magnetic. According to the Direct Selling News in 2009, out of the thousands of start-up companies in the last century, only 69 have made it to $100 million in annual sales, and only 11 companies have made it to $1 billion in annual sales. Even with that low success rate, still people join in droves when a start-up with a good story crops up. “Everyone loves a start-up!”

This can cause leaders to look to the company for ways to keep their organizations intact. Often times, to stave off competition, companies will match new products or establish new divisions to stay current with the budding opportunities created by competing companies in the industry. By offering the same products or divisions, the hope is that distributors will stay with the established company rather than leaving to the new, fresh but risky opportunity. Another strategy that companies use is global expansion—taking their old story into new countries that are prime for growth. Or, they may even discourage their distributor network from participating in any other opportunity by tightening the policies and procedures—to “stay put, or else!”

This has been the modus operandi for most companies listed with both the Direct Selling Association as well as Direct Selling News. However, these strategies have shown challenges in creating net growth or in preventing net distributor attrition.

Product Expansion and Divisions: Although adding product lines and/or divisions offers more volume choices to the distributor as they share with customers and potential distributors, other issues impede true potential growth. First, most distributors will trade out volume when a new product line is introduced. If a required personal volume requirement is $100 monthly, most distributors will stay at or near that amount. Very little incremental volume is created from multiple product lines within the same compensation plan. Even if the new product is released in order to match a competing product in the industry, many distributors will still sway toward the start-up, ground-floor opportunity.

Some companies create “divisions” where leaders can choose to “carry the flag” of one division over another. This still does not create incremental volume, and the divisive nature of leaders fighting for volume is often treacherous for total company growth and for the morale in the field.

Global Expansion: Opening up new markets with the same product story that has had success at home is definitely a strategy for growth. However, often those market expansions can have a negative effect at home. Most distributors aren't equipped to find success in those markets. Typically, the numbers are just a few who can afford to travel globally or who have a fantastic connection in the new market. These are usually the leaders that built the network at home, who take their eye to a foreign market and often leave the field at home feeling left out or abandoned. The company also tends to focus resources on the new markets, often trailing in the support for the home market, or even overspending the budget in order to appease the demand for market expansion from leaders. As new distributors are excitedly joining in the foreign market, discouraged distributors are slowing down at home, or are spending money they don't have in an effort to “follow their leader” into a foreign market to build.

Tightening Policies and Procedures: In a measure to place fear in the hearts of its distributor force, many companies fall into tightening the policies and procedures—threatening the income or distributor genealogy of anyone who tries to participate in an alternate MLM opportunity. In some cases, these new policies fall into a very grey area with the guidelines with Attorneys General established in each state. While keeping the tax status of the field as “independent distributor” the new policies confuse the freedom of that status with the bondage of fear. In time, leaders that want to participate somewhere else come to resent such practices if they feel they have built a strong organization that continues to produce volume for the company. This dampens the spirit of growth and longevity at the company.

Therefore, for these and other reasons, existing direct marketing companies and practices are limited in their ability to grow and to respond to competition.

### BRIEF SUMMARY OF THE INVENTION

Implementations of the invention provide systems, methods, and computer-readable media for providing systems and performing methods of extending direct marketing services to companies not having their own direct marketing networks. According to an implementation, a method for extending direct marketing services entails utilizing an existing direct marketing network to provide direct marketing services to a company that does not have its own direct marketing network, comprising overlaying a new compensation system on an existing direct marketing network, the new compensation system corresponding to distribution of one or more products of the company that does not have its own direct marketing network, wherein the new compensation system is overlaid on the existing direct marketing network without disturbing an existing compensation system for existing products already distributed through the existing direct marketing network.

The new compensation system and the existing compensation system govern compensation of distributors within the direct marketing network for distribution of the one or more products of the company that does not have its own direct marketing network and the existing products, respectively. In some implementations, the new compensation system substantially replicates the manner of compensation of distributors in the existing compensation system. In other implementations, the new compensation system substantially differs the manner of compensation of distributors from the manner of compensation of distributors in the existing compensation system.

In certain implementations, the new compensation system is a first new compensation system and the company that does not have its own direct marketing network is a first company that does not have its own direct marketing network. The method may then entail utilizing the existing direct marketing network to provide direct marketing services to a second company that does not have its own direct marketing network, comprising overlaying a second new compensation system on the existing direct marketing network, the second new compensation system corresponding to distribution of one or more products of the second company that does not have its own direct marketing network, wherein the second new compensation system is overlaid on the existing direct marketing network without disturbing the existing compensation system for existing products already distributed through the existing direct marketing network and without disturbing the first new compensation system.

In some implementations, the one or more products of the company that does not have its own direct marketing network are related to the existing products, such that distribution of the one or more products synergistically benefits distribution of the existing products.

In some instances, upon overlaying the new compensation system on the existing direct marketing network, distributors of the existing direct marketing network may only receive compensation under the new compensation system upon achievement of a minimum level of personal distribution of the of the one or more products of the company that does not have its own direct marketing network. In certain cases, upon overlaying the new compensation system on the existing direct marketing network, distributors of the existing direct marketing network only receive compensation under the existing compensation system upon achievement of a minimum level of personal distribution of the of the existing products.

In selected instances, upon overlaying the new compensation system on the existing direct marketing network, distributors of the existing direct marketing network only receive compensation under the new compensation system upon achievement of a minimum level of downline distribution of the of the one or more products of the company that does not have its own direct marketing network. In selected cases, upon overlaying the new compensation system on the existing direct marketing network, distributors of the existing direct marketing network only receive compensation under the existing compensation system upon achievement of a minimum level of downline distribution of the of the existing products.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a representative computer system environment in which embodiments of the invention may be practiced;

FIG. 2 shows a representative networked computer system environment in which embodiments of the invention may be practiced;

FIG. 3 shows a representative direct marketing network; and

FIG. 4 illustrates a representative overlay of a direct marketing compensation plan over an existing direct marketing network.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide systems, methods, and computer-readable media for providing systems and performing methods of extending direct marketing services to companies not having their own direct marketing networks. According to an embodiment, a method for extending direct marketing services entails utilizing an existing direct marketing network to provide direct marketing services to a company that does not have its own direct marketing network, comprising overlaying a new compensation system on an existing direct marketing network, the new compensation system corresponding to distribution of one or more products of the company that does not have its own direct marketing network, wherein the new compensation system is overlaid on the existing direct marketing network without disturbing an existing compensation system for existing products already distributed through the existing direct marketing network.

The new compensation system and the existing compensation system govern compensation of distributors within the direct marketing network for distribution of the one or more products of the company that does not have its own direct marketing network and the existing products, respectively. In some embodiments, the new compensation system substantially replicates the manner of compensation of distributors in the existing compensation system. In other embodiments, the new compensation system substantially differs the manner of compensation of distributors from the manner of compensation of distributors in the existing compensation system.

In certain embodiments, the new compensation system is a first new compensation system and the company that does not have its own direct marketing network is a first company that does not have its own direct marketing network. The method may then entail utilizing the existing direct marketing network to provide direct marketing services to a second company that does not have its own direct marketing network, comprising overlaying a second new compensation system on the existing direct marketing network, the second new compensation system corresponding to distribution of one or more products of the second company that does not have its own direct marketing network, wherein the second new compensation system is overlaid on the existing direct marketing network without disturbing the existing compensation system for existing products already distributed through the existing direct marketing network and without disturbing the first new compensation system.

In some embodiments, the one or more products of the company that does not have its own direct marketing network are related to the existing products, such that distribution of the one or more products synergistically benefits distribution of the existing products.

In some instances, upon overlaying the new compensation system on the existing direct marketing network, distributors of the existing direct marketing network may only receive compensation under the new compensation system upon achievement of a minimum level of personal distribution of the of the one or more products of the company that does not have its own direct marketing network. In certain cases, upon overlaying the new compensation system on the existing direct marketing network, distributors of the existing direct marketing network only receive compensation under the existing compensation system upon achievement of a minimum level of personal distribution of the of the existing products.

In selected instances, upon overlaying the new compensation system on the existing direct marketing network, distributors of the existing direct marketing network only receive compensation under the new compensation system upon achievement of a minimum level of downline distribution of the of the one or more products of the company that does not have its own direct marketing network. In selected cases, upon overlaying the new compensation system on the existing direct marketing network, distributors of the existing direct marketing network only receive compensation under the existing compensation system upon achievement of a minimum level of downline distribution of the of the existing products.

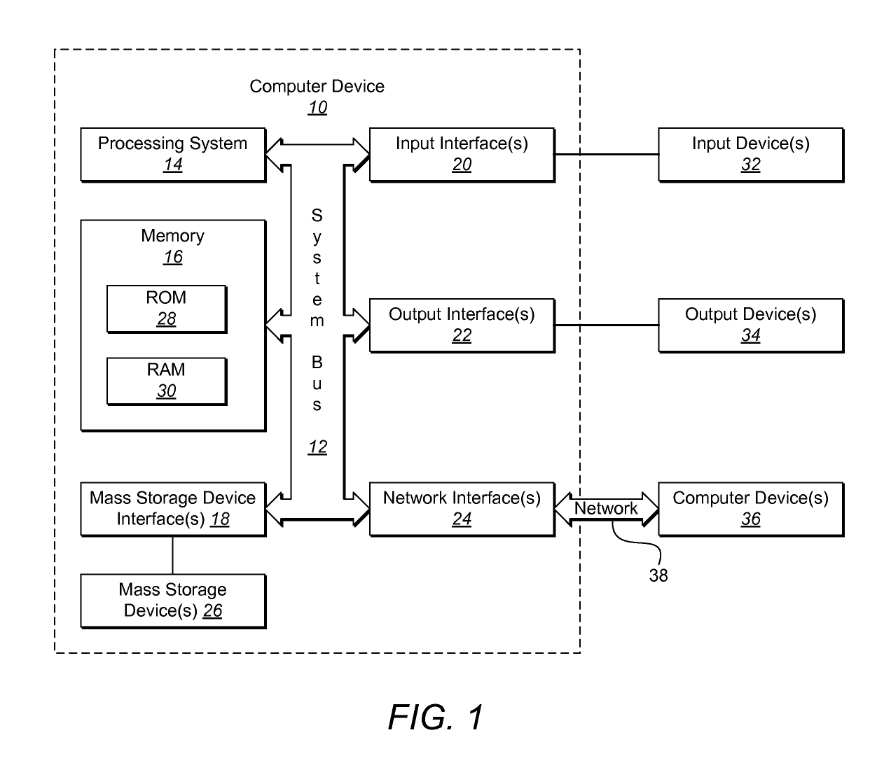

FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 1, a representative system for implementing embodiments of the invention includes computer device 10, which may be a general-purpose or special-purpose computer or any of a variety of consumer electronic devices. For example, computer device 10 may be a personal computer, a notebook computer, a netbook, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a magnetic hard disk, a removable magnetic disk, a magnetic cassette, an optical disk, or from a communication connection, which may also be viewed as a computer-readable medium.

Memory 16 includes one or more computer-readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer-readable medium. Mass storage devices 26 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

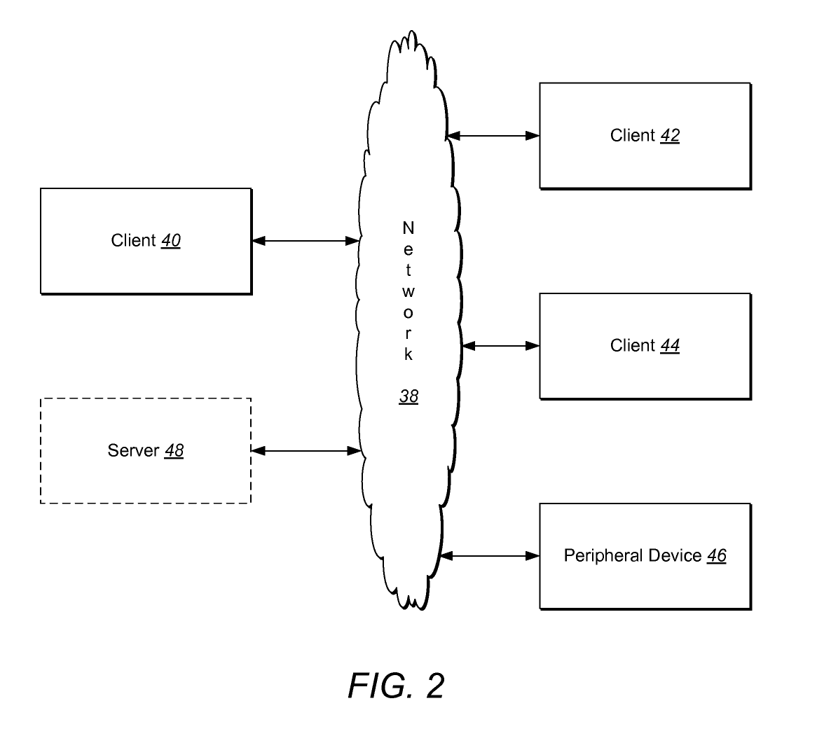

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices (illustrated as multifunctional peripheral (MFP) MFP 46) across network 38. While FIG. 2 illustrates an embodiment that includes a client 40, two additional clients, client 42 and client 44, one peripheral device, MFP 46, and optionally a server 48, which may be a print server, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

Similarly, embodiments of the invention embrace cloud-based architectures where one or more computer functions are performed by remote computer systems and devices at the request of a local computer device. Thus, returning to FIG. 2, the client 40 may be a computer device having a limited set of hardware and/or software resources. Because the client 40 is connected to the network 38, it may be able to access hardware and/or software resources provided across the network 38 by other computer devices and resources, such as client 42, client 44, server 48, or any other resources. The client 40 may access these resources through an access program, such as a web browser, and the results of any computer functions or resources may be delivered through the access program to the user of the client 40. In such configurations, the client 40 may be any type of computer device or electronic device discussed above or known to the world of cloud computing, including traditional desktop and laptop computers, smart phones and other smart devices, tablet computers, or any other device able to provide access to remote computing resources through an access program such as a browser.

Embodiments of the invention provide a strategy to leverage a direct marketing distributor network. Rather than playing defense with multiple product lines, divisions, global expansion, or even policy changes, a direct marketing company may utilize multiple, separate MLM opportunities in an overlay concept. Through this overlay concept, distributors can participate in multiple ventures while keeping their distributor organization intact. The benefits of this strategy fortify the strength of the distributor network; while at the same time promoting growth and longevity with each company that is part of the overlay strategy.

Overlay Concept: The concept of an overlay is quite simple. The established distributor network is offered additional MLM opportunities in a “start-up” kind of way, while at the same time protecting their downline genealogies if they continue sales activity in each company. The linkage between distributors, who sponsored other distributors and so on, is called the genealogy tree. When an additional opportunity is presented, the genealogy tree is copied, or overlaid, onto the new compensation plan, keeping all those relationships intact. However, in order for a distributor to be guaranteed the integrity of his/her downline, he/she must remain active (continued sales) in order to do so. As a result, incremental income is created for the distributor due to the overlay of his/her downline.

The overlay also benefits the companies involved. By leveraging the distributor network in the overlay, distributors attracted initially to company A will also become active in company B in order to maintain their downline. Conversely, distributors who are attracted first to company B will also be active in company A in order to keep those downline relationships intact. Because this strategy protects leaders as they put all their efforts to build a network, recruiting established, proven leaders and their downlines into the direct marketing network is much more likely. These leaders are attracted to the true incremental growth in their overall business with multiple opportunities running through their organization. This also benefits the companies that participate in the overlay strategy due to the quality of leader that participates in the opportunity. It highly affects the growth curve for the company in a positive way.

Market and Company Selection for Overlay: The selection process for companies that participate in the overlay strategy provides an additional layer of benefit. The suite of companies might only carry complementary products, not competing products. So as the distributor network is tied into the overlay to protect their downlines, a competing company with a similar product outside of the overlay group has little influence to entice the distributor force away. The stronger the suite of companies and products, the more leverage they provide to each other in keeping the distributor network intact. The whole is much greater than the sum of the parts.

Advanced, Unique Product selection: Many unique products, including products with incredible patent protection are created that would be best sold through an MLM company. Often, the inventor/owner of the product will not align with an MLM because the model usually requires they have only a small participation in the upside as an OEM model. Sometimes, the inventor/owner will get passionate about MLM and just create his or her own start-up in order to have greater upside potential. However, the probability of long-term success is limited due to the lack of experienced MLM leadership and corporate structure.

The direct marketing overlay strategy provides a way for these great products and the inventors/owners to participate in the upside, while leveraging the expertise of an experienced MLM partner and its distributor network through joint venture opportunities. These products, again, benefit all participating companies by raising the level of distributor commitment to unique opportunities while protecting their downline structure.

Investor Advantage: By using joint ventures in the overlay group, investment opportunities arise for multiple returns on the distributor network sales. Even opportunities for overlay companies to invest in joint ventures of other overlay companies arise in this strategy. Each additional overlay venture offers more stability from leveraging the distributor network, creating favorable investor advantages.

The typical strategies used by MLM companies today will actually have greater benefit to companies participating in the direct marketing overlay group. Adding new product lines will enhance the commitment of distributors to leverage those products in their network. Global expansion for a company can be rolled out at the proper time and pace rather than in an effort to provide a “sticky” strategy for stagnating leaders. And a company would not need to bruise its relationship with the distributor force by instilling fear tactics in its policies and procedures. Growth and longevity would come from the carrot, not the stick.

Rolled out properly, with the right champions and a timely product set, the direct marketing overlay concept can truly consolidate the MLM industry providing a long-term home for an army of leaders. It will attract new MLM participants through a variety of unique products most likely never offered before as a financial sales opportunity to the masses. And it will provide tremendous growth opportunities for participating overlay companies while massively limiting the attrition through the overlay network promise of protected downlines.

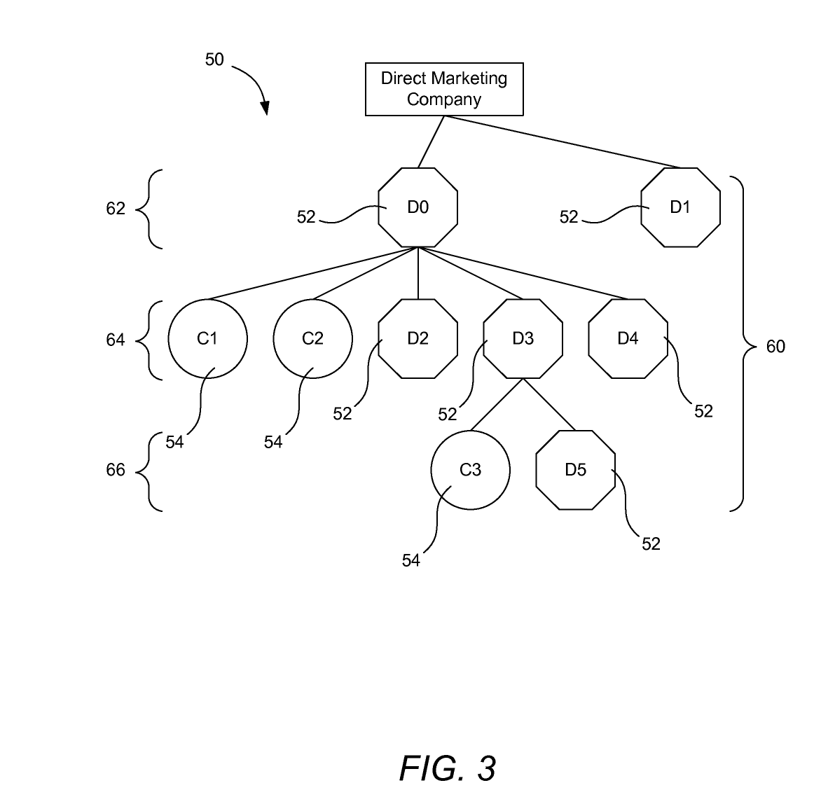

To illustrate how methods in accordance with the foregoing principles might function, FIG. 3 a representative network marketing organization 50. FIG. 1 depicts a network marketing organization 20 that has six distributors 52 and three customers 54. For illustration purposes, the customers C1-C3 54 are depicted as circles, and distributors D0-D5 52 are depicted as octagons. It will be understood, that other embodiments can include more members in the network marketing organization 20 than are depicted in FIG. 3. For example, some network marketing organizations 20 can include hundreds or thousands of members, multiple distributors 52 in various levels, and many levels, such as up to dozens, hundreds, or thousands of levels in respective downlines 60. In the illustrated network, the downlines have three levels: level zero 62, level one 64, and level three 66.

As mentioned, network marketing is a business model that combines direct retail marketing with a sales force of independent contractors. Network marketing is an alternate channel to traditional store-based retail sales and marketing. Network marketing businesses usually function by enrolling unsalaried distributors 52 to sell products. Distributors 52 may earn additional sales commissions based on the sales of people recruited into their downline 60. A distributor's downline 60 includes the distributor's direct recruits, recruits' recruits and so on such that there may be multiple levels 62, 64, 66 of people receiving commissions from one person's sales. Thus, as a distributor's downline 60 grows, the distributor 52 has increased earning abilities.

Accordingly, as shown in FIG. 3, a primary distributor 52, D0, has recruited two customers 54, C1 and C2, into his/her front line or first level 64. In some embodiments, customers recruited by a distributor 52 can be located on the recruiting distributor's frontline or first level 64, as shown. Distributor D0 has also recruited three additional distributors 52, D2-D5, into his front line. Downline distributor D2 has also recruited customer 54, C3, and distributor 52, D5, into his front line, which is level two 64 of D0's downline 60. Other distributors 52, such as distributor D1 may have their own downlines 60 as well.

Customers 54 can be individuals who buy products through a recruiting distributor 52. Some customers 54 can be retail customers who buy products with or without a purchasing commitment or quota. Enrolling distributors 52 can get a retail markup plus commissions on products sold to customers 54. Other customers 54 can be preferred customers who purchase products on a subscription basis in return for a product price without the retain markup. Some preferred customers may be auto-ship customers, which automatically purchase and receive a certain amount of product from the network marketing organization 50 monthly, quarterly, annually or otherwise periodically.

In some embodiments, when customers 52 and/or distributors 54 purchase products from the network marketing organization 50, the purchases are made through the recruiting distributor 52 and/or are attributed to the recruiting distributor. Thus, a compensation system of the network marketing organization 50 can be configured to recognize who purchased each product, and where the purchaser is positioned in the network marketing organization 50. In this way, the appropriate upline distributor(s) 52 can be identified, credited, and ultimately compensated for purchases made by distributors 52 and customers 54 in his or her downline 60.

While a traditional direct marketing company is limited to distributing its own products and services through the downline networks of distributors 54, according to embodiments of the invention, direct marketing companies and their downline networks of distributors 54 may be utilized in overlay with products of multiple companies. In this fashion, companies can achieve the benefits of an experienced direct marketing provider without being required to build up a direct marketing network from scratch. The direct marketing company is benefited by providing its distributor network with additional marketing opportunities, thereby increasing the ability of the direct marketing company to retain its distributor networks, for distributors 52 to retain their downlines, and for customers to obtain new products. Meanwhile, manufacturers and other distributors are able to take advantage of an experienced and established direct marketing company and network without having to suffer through the inefficiencies, problems, and failures of start-up.

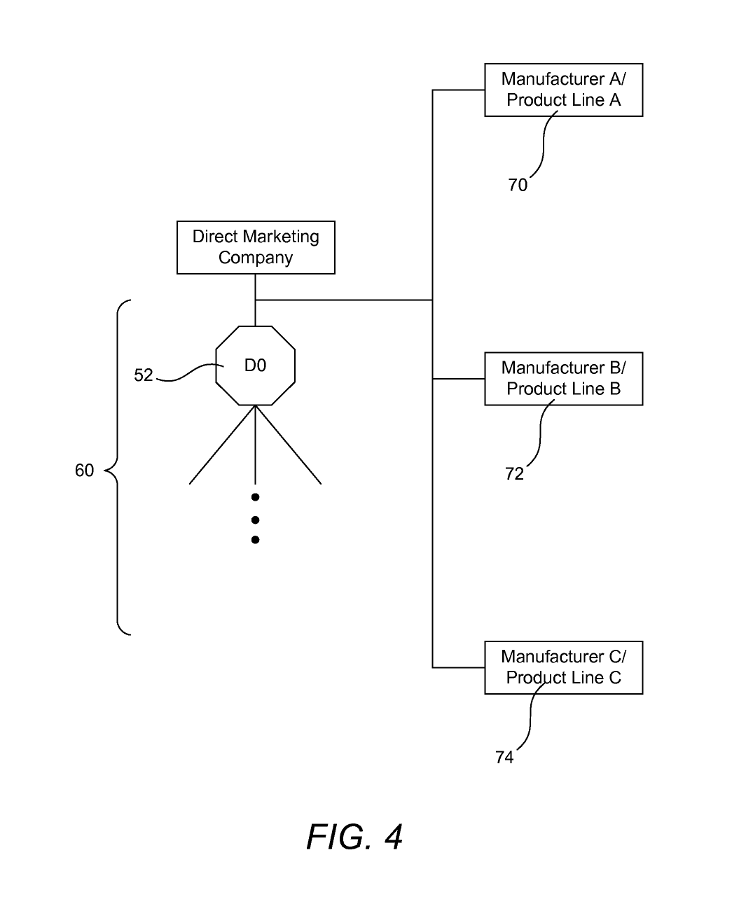

FIG. 4 illustrates the overlay concept as it may be practiced. As discussed with respect to FIG. 3, a direct marketing company has a network of distributors 52 established in their various downlines 60. The direct marketing company originally has its own line of products that is marketed and distributed by its distributor network. Meanwhile, manufacturer A 70 manufactures products that it wishes to sell and distribute, but lacks its own direct marketing network. Manufacturer A might have one or more brick-and-mortar locations through which it distributes its product, but it is unable to achieve the benefits of direct marketing without the difficulties of establishing a direct marketing network. Traditionally, for manufacturer A 70 to realize the benefits of direct marketing, it would have to recruit persons knowledgeable with respect to direct marketing practices, and then would have to go through the difficulties of start-up with the normal high rates of failure, etc.

Instead, according to embodiments of the invention, manufacturer A 70 can utilize the established direct marketing network of the direct marketing company. An agreement is reached between the direct marketing company and manufacturer A 70, such that certain products of manufacturer A are overlaid on all or part of the direct marketing network of the direct marketing company. The products may be related to products already distributed by the direct marketing network, such that its distributors 52 are familiar with the type of product and are motivated to sell the additional products, not just through the existing compensation structure, which can often be mirrored, but also through increased sales across all product lines by increased overall interest of customers 54.

To further motivate distributors 52 to participate in promoting the new products, in embodiments of the invention, distributors 52 may only be permitted to participate in their downlines' success in selling the new products to the extent that the distributors 52 actively participate in promoting the new products. Thus, the direct marketing company may utilize systems that track activities of distributors 52 in the various downlines 60 with respect to the various products and/or product lines. The system may compare the activities with respect to baseline rules established with respect to each product and/or product line, and may permit compensation for downline activity only upon achievement of a certain level of participation with respect to that product and/or product line.

As is illustrated in FIG. 4, the opportunities for the direct marketing company need not be limited to a single manufacturing partner. Additional partners may be recruited from time to time to enhance the opportunities for the direct marketing company, its distributor network, and for partners of the direct marketing company. Thus, the direct marketing company and its distributor network may sell products and/or product lines from both the direct marketing company itself and manufacturer A 70 as described above, as well as from other manufacturers such as manufacturer B 72 and manufacturer C 74 or any other number of manufacturers or distributors.

The foregoing examples have been discussed with respect to creating incremental sales volumes in a direct marketing network while providing the benefits of an experienced and established direct marketing organization for distribution of products of manufacturers and other companies that do not have their own direct marketing organization. The principles discussed herein can also be used to create incremental sales volumes across new and additional product lines within an existing direct marketing organization. Thus, for example, a direct marketing organization could introduce a new product line and establish a new compensation system associated with the new product line, and could overlay the new compensation system over the existing organization.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A method for extending direct marketing services to companies not having their own direct marketing networks comprising:
utilizing an existing direct marketing network to provide direct marketing services to a company that does not have its own direct marketing network, comprising overlaying a new compensation system on an existing direct marketing network, the new compensation system corresponding to distribution of one or more products of the company that does not have its own direct marketing network, wherein the new compensation system is overlaid on the existing direct marketing network without disturbing an existing compensation system for existing products already distributed through the existing direct marketing network.

2. A method as recited in claim 1, wherein the new compensation system and the existing compensation system govern compensation of distributors within the direct marketing network for distribution of the one or more products of the company that does not have its own direct marketing network and the existing products, respectively.

3. A method as recited in claim 1, wherein the new compensation system substantially replicates the manner of compensation of distributors in the existing compensation system.

4. A method as recited in claim 1, wherein the new compensation system substantially differs the manner of compensation of distributors from the manner of compensation of distributors in the existing compensation system.

5. A method as recited in claim 1, wherein the new compensation system is a first new compensation system and the company that does not have its own direct marketing network is a first company that does not have its own direct marketing network, further comprising:
utilizing the existing direct marketing network to provide direct marketing services to a second company that does not have its own direct marketing network, comprising overlaying a second new compensation system on the existing direct marketing network, the second new compensation system corresponding to distribution of one or more products of the second company that does not have its own direct marketing network, wherein the second new compensation system is overlaid on the existing direct marketing network without disturbing the existing compensation system for existing products already distributed through the existing direct marketing network and without disturbing the first new compensation system.

6. A method as recited in claim 1, wherein the one or more products of the company that does not have its own direct marketing network are related to the existing products, such that distribution of the one or more products synergistically benefits distribution of the existing products.

7. A method as recited in claim 1, wherein upon overlaying the new compensation system on the existing direct marketing network, distributors of the existing direct marketing network only receive compensation under the new compensation system upon achievement of a minimum level of personal distribution of the of the one or more products of the company that does not have its own direct marketing network.

8. A method as recited in claim 1, wherein upon overlaying the new compensation system on the existing direct marketing network, distributors of the existing direct marketing network only receive compensation under the existing compensation system upon achievement of a minimum level of personal distribution of the of the existing products.

9. A method as recited in claim 1, wherein upon overlaying the new compensation system on the existing direct marketing network, distributors of the existing direct marketing network only receive compensation under the new compensation system upon achievement of a minimum level of downline distribution of the of the one or more products of the company that does not have its own direct marketing network.

10. A method as recited in claim 1, wherein upon overlaying the new compensation system on the existing direct marketing network, distributors of the existing direct marketing network only receive compensation under the existing compensation system upon achievement of a minimum level of downline distribution of the of the existing products.

11. A non-transitory computer-readable medium containing computer program code to cause a computer to execute a method of extending direct marketing services to either companies not having their own direct marketing networks or a new product line not yet being distributed by an existing direct marketing network, the method comprising:
utilizing an existing direct marketing network to provide direct marketing services to either a company that does not have its own direct marketing network or to a new product line not yet being distributed by the existing direct marketing network, comprising overlaying a new compensation system on an existing direct marketing network, the new compensation system corresponding to distribution of one or more products of the company that does not have its own direct marketing network or to distribution of the new product line, wherein the new compensation system is overlaid on the existing direct marketing network without disturbing an existing compensation system for existing products already distributed through the existing direct marketing network.

12. A non-transitory computer-readable medium as recited in claim 11, wherein the new compensation system and the existing compensation system govern compensation of distributors within the direct marketing network for distribution of the one or more products of the company that does not have its own direct marketing network or the new product line, and the existing products, respectively.

13. A non-transitory computer-readable medium as recited in claim 11, wherein the new compensation system substantially replicates the manner of compensation of distributors in the existing compensation system.

14. A non-transitory computer-readable medium as recited in claim 11, wherein the new compensation system substantially differs the manner of compensation of distributors from the manner of compensation of distributors in the existing compensation system.

15. A non-transitory computer-readable medium as recited in claim 11, wherein the new compensation system is a first new compensation system and the company that does not have its own direct marketing network or the new product line is a first company that does not have its own direct marketing network or a first new product line, further comprising:
utilizing the existing direct marketing network to provide direct marketing services to a second company that does not have its own direct marketing network or to a second new product line, comprising overlaying a second new compensation system on the existing direct marketing network, the second new compensation system corresponding to distribution of one or more products of the second company that does not have its own direct marketing network or to distribution of the second new product line, wherein the second new compensation system is overlaid on the existing direct marketing network without disturbing the existing compensation system for existing products already distributed through the existing direct marketing network and without disturbing the first new compensation system.

16. A non-transitory computer-readable medium as recited in claim 11, wherein the one or more products of the company that does not have its own direct marketing network or the first new product line are related to the existing products, such that distribution of the one or more products or the new product line synergistically benefits distribution of the existing products.

17. A non-transitory computer-readable medium as recited in claim 11, wherein upon overlaying the new compensation system on the existing direct marketing network, distributors of the existing direct marketing network only receive compensation under the new compensation system upon achievement of a minimum level of personal distribution of the one or more products of the company that does not have its own direct marketing network or of the new product line.

18. A non-transitory computer-readable medium as recited in claim 11, wherein upon overlaying the new compensation system on the existing direct marketing network, distributors of the existing direct marketing network only receive compensation under the existing compensation system upon achievement of a minimum level of personal distribution of the existing products.

19. A non-transitory computer-readable medium as recited in claim 11, wherein upon overlaying the new compensation system on the existing direct marketing network, distributors of the existing direct marketing network only receive compensation under the new compensation system upon achievement of a minimum level of downline distribution of the one or more products of the company that does not have its own direct marketing network or of the new product line.

20. A non-transitory computer-readable medium as recited in claim 11, wherein upon overlaying the new compensation system on the existing direct marketing network, distributors of the existing direct marketing network only receive compensation under the existing compensation system upon achievement of a minimum level of downline distribution the existing products.
